(19) United States
(12) Patent Application Publication
(10) Pub. No.: US 2018/0181961 A1
(43) Pub. Date: Jun. 28, 2018

(54) SYSTEM AND METHOD FOR CONDUCTING A PAYMENT TRANSACTION

(71) Applicant: Mastercard Asia/Pacific Pte Ltd, Singapore (SG)

(72) Inventor: Syam Sasidharan Nair, Singapore (SG)

(73) Assignee: Mastercard Asia/Pacific Pte Ltd, Singapore (SG)

(21) Appl. No.: 15/855,572

(22) Filed: Dec. 27, 2017

(30) Foreign Application Priority Data
Dec. 28, 2016 (SG) 10201610909R

(51) Int. Cl. G06Q 20/40; G06Q 20/32

(52) U.S. Cl. CPC G06Q 20/4014; G06Q 20/34; G06Q 20/3278; G06Q 20/3223

(57) ABSTRACT

A system and method for conducting a payment transaction. The system comprises: a sensor for detecting a mobile device and for transmitting an identifier obtained from the mobile device; a merchant server configured to receive the identifier from the sensor and to determine, based on the identifier, an availability of a transaction code generated for a pre-authorisation of the payment transaction, wherein upon a positive determination of the transaction code, the merchant server transmits identification data associated with the identifier for verification of a customer of the payment transaction; and a payment terminal in communication with the merchant server for receiving the identification data from the merchant server and for transmitting a transaction amount of the payment transaction and the verification of the customer to the merchant server, wherein the merchant server transmits the received transaction amount and the transaction code to a payment network for completing the payment transaction.

### CROSS-REFERENCE TO RELATED APPLICATIONS

This application claims the priority benefit of Singapore Application Serial No. 10201610909R, filed Dec. 28, 2016, which is incorporated herein by reference in its entirety.

### FIELD OF INVENTION

The present invention relates broadly, but not exclusively, to a system and a method for conducting a payment transaction.

### BACKGROUND

Mobile payment is a method of performing payment transaction using a customer mobile device. This type of payment method provides convenience to the customers since the customers are no longer required to carry a physical payment card and present it to the cashier in a physical store each time a payment transaction is made.

Typically, payment card data is accessible via a mobile payment application installed in the customer mobile device. The payment card data may be stored in a secure element (SE) of the mobile device, or using host card emulation (HCE). The mobile payment application usually allows payment card data of more than one payment card to be stored and accessed. The security features involved in a mobile payment process, such as the password required to activate the mobile payment application and/or initiate a mobile payment, are arguably superior to that of the physical payment card. This may reduce the vulnerability of a mobile payment process.

Mobile payment can be made at a payment terminal of the store. For example, a customer may wave his or her mobile device (that is equipped with near-field communication (NFC) capability) near an NFC reader at the payment terminal for transferring the payment card details. Even though mobile payment provides numerous benefits, some customers are still reluctant to use this payment method, noting that this payment method, akin to using a physical payment card, still requires the customers to present a physical item, i.e. the mobile device in this case, at the payment terminal when making payment.

A need therefore exists to provide a system and method for conducting a payment transaction that addresses at least one of the problems above or to provide a useful alternative.

### SUMMARY

According to a first aspect of the present invention, there is provided a system for conducting a payment transaction, the system comprising:

a sensor for detecting a mobile device and for transmitting an identifier obtained from the mobile device;

a merchant server configured to receive the identifier from the sensor and to determine, based on the identifier, an availability of a transaction code generated for a pre-authorisation of the payment transaction, wherein upon a positive determination of the transaction code, the merchant server transmits identification data associated with the identifier for verification of a customer of the payment transaction; and

a payment terminal in communication with the merchant server for receiving the identification data from the merchant server and for transmitting a transaction amount of the payment transaction and the verification of the customer to the merchant server, wherein the merchant server transmits the received transaction amount and the transaction code to a payment network for completing the payment transaction.

Prior to receiving the identifier from the sensor, the merchant server may be configured to:

receive, from the mobile device, the identifier for the payment transaction and payment instrument details used to fund the payment transaction;

transmit the payment instrument details to the payment network to initiate pre-authorisation of the payment transaction;

receive, from the payment network, the transaction code generated for the pre-authorisation of the payment transaction; and

store, in a merchant database, the transaction code received from the payment network with the identifier.

The merchant server may be further configured to:

process the identifier received from the sensor against a customer database to locate the identification data associated with the identifier; and

transmit the identification data associated with the identifier to the payment terminal for verification of the customer.

The payment terminal may be further configured to:

display the identification data received from the merchant server on a display screen; and

allow an input for verification of the customer and for obtaining the transaction amount of the payment transaction.

The verification of the customer may comprise a comparison of the identification data associated with the identifier.

The merchant server may be further configured to retrieve the transaction code from the merchant database based on the identifier received from the sensor.

The identification data may comprise one or more of: a customer picture, a customer name, a customer identification number, a phone number, biometric data and a password.

The merchant server may be further configured to transmit a notification to the mobile device upon completion of the payment transaction.

According to a second aspect of the present invention, there is provided a computer-implemented method for conducting a payment transaction, the method comprising the steps of:

receiving, from a sensor, an identifier associated with a mobile device;

determining, based on the identifier, an availability of a transaction code generated for a pre-authorisation of the payment transaction;

upon a positive determination of the transaction code, transmitting identification data associated with the identifier to a payment terminal for verification of a customer of the payment transaction;

receiving, from the payment terminal, a transaction amount of the payment transaction and the verification of the customer; and

transmitting the received transaction amount and the transaction code to a payment network for completing the payment transaction.

Prior to receiving the identifier associated with the mobile device, the method may further comprise the steps of:

receiving, from the mobile device, the identifier for the payment transaction and payment instrument details used to fund the payment transaction;

transmitting the payment instrument details to the payment network to initiate pre-authorisation of the payment transaction;

receiving, from the payment network, the transaction code generated for the pre-authorisation of the payment transaction; and

storing, in a merchant database, the transaction code received from the payment network with the identifier.

The method may further comprise the steps of:

processing the identifier received from the sensor against a customer database to locate the identification data associated with the identifier; and

transmitting the identification data associated with the identifier to the payment terminal for verification of the customer.

The method may further comprise the step of retrieving the transaction code from the merchant database based on the identifier received from the sensor.

The method may further comprise the step of transmitting a notification to the mobile device upon completion of the payment transaction.

According to a third aspect of the present invention, there is provided a non-transitory computer-readable medium having stored thereon computer instructions executable to perform a method for conducting a payment transaction, the method comprising the steps of:

receiving, from a sensor, an identifier associated with a mobile device;

determining, based on the identifier, an availability of a transaction code generated for a pre-authorisation of the payment transaction;

upon a positive determination of the transaction code, transmitting identification data associated with the identifier to a payment terminal for verification of a customer of the payment transaction;

receiving, from the payment terminal, a transaction amount of the payment transaction and the verification of the customer; and

transmitting the received transaction amount and the transaction code to a payment network for completing the payment transaction.

### BRIEF DESCRIPTION OF THE DRAWINGS

Embodiments of the invention are provided by way of example only, and will be better understood and readily apparent to one of ordinary skill in the art from the following written description and the drawings, in which:

FIG. 1 shows a diagram illustrating a system for conducting a payment transaction and a scenario in which the payment transaction is being conducted in accordance with an example embodiment.

FIG. 2 shows a diagram illustrating a customer making payment at a payment terminal in accordance with an example embodiment.

FIG. 3 shows a flow chart illustrating a method for conducting a payment transaction in accordance with an example embodiment.

FIG. 4 shows a schematic diagram illustrating a computer suitable for implementing the method and system of the example embodiments.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “obtaining”, “estimating”, “assigning”, “creating”, “predicting”, “capturing”, “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers.

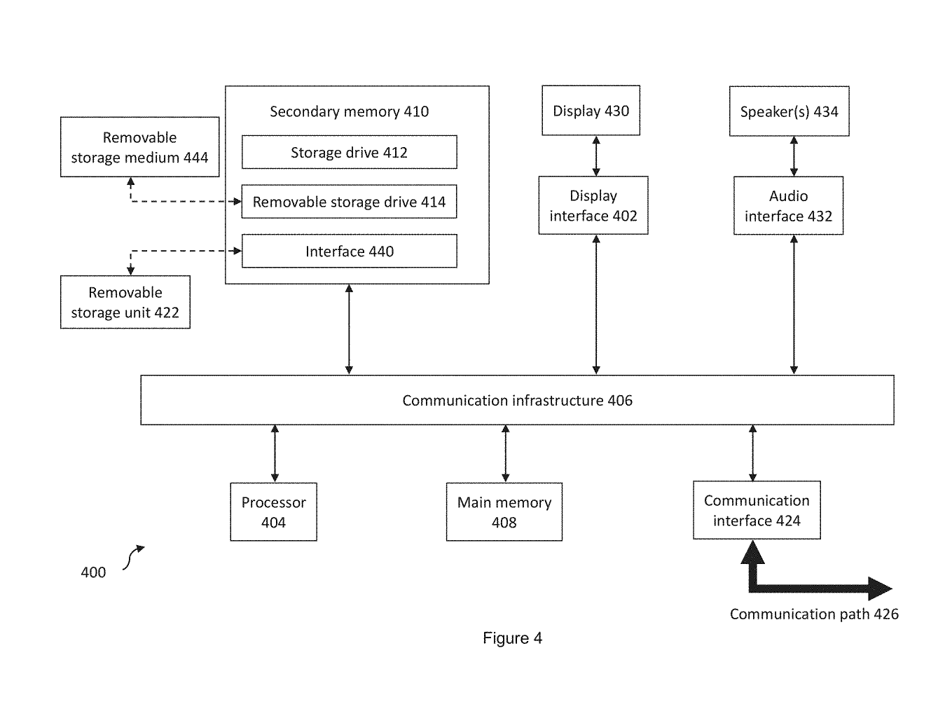

As used herein, the terms “module” and “database” refer to a single computing device or a plurality of interconnected computing devices which operate together to perform a particular function. That is, the “module” and “database” may be contained within a single hardware unit or be distributed among several or many different hardware units. An exemplary computing device which may be operated as a “module” and “database” is described below with reference to FIG. 4.

Digital Secure Remote Payment (DSRP) developed by MasterCard® is a payment technology which allows remote payments to be made in accordance with the EMV standard. Typically, DSRP is used with mobile wallet applications to perform in-app purchases. The mobile wallet applications are developed by a mobile wallet provider, for example a payment network such as Mastercard®, an issuer such as Citibank®, or a third-party wallet provider such as Google® or Paypal®. More details regarding DSRP may be found at and in the document “MasterCard Cloud-Based Payments Implementation Guide—version 1.0” dated February 2015 and available from http://www.mastercardconnect.com.

To make a payment using a mobile wallet in a physical store, a customer making the payment usually initiates a mobile wallet application installed in a mobile device near a payment terminal of the store. The customer then waves the mobile device near an NFC reader at the payment terminal for transferring details of a payment instrument, such as a credit card, for completing a payment transaction. In the description below, the DSRP technology is adapted to be used with sensors installed in the store for allowing the payment to be made in the store using the mobile device without having to establish a communication between the mobile device and the payment terminal. It will be appreciated that other implementations of EMV-grade security for card-not-present transactions may also be used in place of DSRP. Specifically, the sensors are configured to retrieve transaction data required, such as a DSRP cryptogram and an identifier of the mobile wallet, from the mobile device in order to complete the payment transaction, thus providing customers with a hands-free payment experience at the payment terminal.

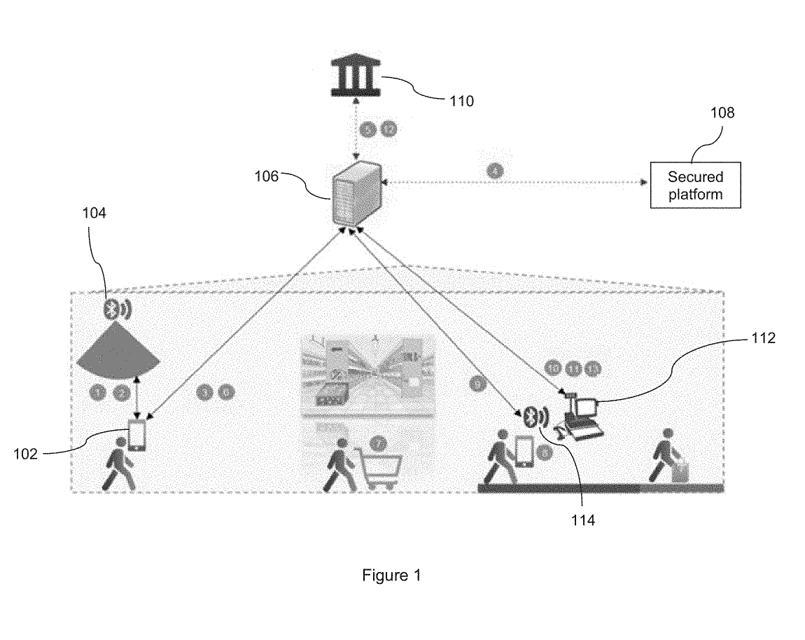

FIG. 1 shows a diagram illustrating a system for conducting a payment transaction and a scenario in which the payment transaction is being conducted in accordance with an example embodiment. As shown in FIG. 1, a customer carrying a mobile device 102 walks into a store. A sensor, represented as a first Bluetooth beacon 104, is installed near the entrance of the store and is configured to communicate with the mobile device 102 if the Bluetooth function of the mobile device 102 is switched on (as shown in point 1). In addition to a mobile wallet application, a merchant application is installed in the mobile device 102. After the Bluetooth connection between the mobile device 102 and the first Bluetooth beacon 104 is being established (as shown in point 2), the merchant application initiates a pre-authorisation process for the payment transaction.

Specifically, the merchant application is activated to display a welcome message and to request for an input on whether the customer wishes to proceed with the pre-authorisation process. Upon receiving a positive input, the merchant application activates the mobile wallet application, which may require user authentication (for example, via input of a password or another cardholder verification method such as biometric authentication) in order for the application to be activated. In some embodiments, if the user has recently authenticated him or herself, said authentication may persist for a predetermined time such that the user does not need to re-authenticate on each invocation of the wallet application. Upon positive authentication, the mobile wallet application generates a DSRP cryptogram which is sent to a merchant server 106 (as shown in point 3). At the same time, an identifier associated with the mobile wallet application is also sent to the merchant server 106.

The merchant server 106 then communicates with a secured platform 108 (as shown in point 4). The secured platform 108 deciphers the DSRP cryptogram and provides the merchant server 106 with the DSRP payment data. The DSRP payment data, such as a payment token, is checkout data required for conducting the pre-authorisation of the payment transaction. An example of the secured platform 108 is MasterCard Digital Enablement Service (MDES).

The merchant server 106 transmits the checkout data to a payment network, e.g. via an acquirer server 110 and/or a payment gateway or payment service provider, to proceed with the pre-authorisation process (as shown in point 5). The pre-authorisation process includes reviewing the request primarily to make sure that the payment instrument selected by the customer in the mobile wallet application is valid. Optionally, if it is known in advance how much the customer intends to spend (or a maximum amount that the customer intends to spend), the pre-authorisation may include checking that the funding account corresponding to the payment instrument has sufficient funds. Upon a successful pre-authorisation, the acquirer server 110 transmits a transaction code generated to the merchant server 106, which is then stored in a merchant database (not shown) with the identifier associated with the mobile wallet application. The merchant server 106 also transmits a notification to the mobile device 102 (as shown in point 6) to inform the customer of the successful pre-authorisation and the customer proceeds to shop in the store (as shown in point 7).

When the customer is ready to check out, he or she proceeds to a payment terminal 112 near the exit of the store (as shown in point 8). The payment terminal 112 includes a display screen that is configured to display information received by the payment terminal 112. The display screen may also include a user interface that allows inputs by a store attendant.

At a short distance from the payment terminal 112, a sensor, represented as a second Bluetooth beacon 114, is installed. The second Bluetooth beacon 114 is configured to detect the mobile device 102 of the customer while the customer is waiting to make payment at the payment terminal 112 and to retrieve the mobile wallet identifier and identification data associated with the mobile wallet application installed in the mobile device 102. The retrieved information is transmitted by the second Bluetooth beacon 114 to the merchant server 106 (as shown in point 9). The distance of the mobile device 102 can also be determined using a distance ranking triangulation algorithm and the distance information is also transmitted to the merchant server 106.

Upon receiving the mobile wallet identifier, the merchant server 106 checks against the merchant database to determine an availability of a corresponding transaction code which has been generated as a result of the pre-authorisation process and which corresponds to the received identifier. Upon a positive determination of the transaction code, the merchant server 106 transmits identification data received from the second Bluetooth beacon 114 to the payment terminal 112. The identification data are displayed on the display screen for verification of the customer by the store attendant.

The identification data may be obtained directly from the mobile device 102 (as shown in point 3) or from the secured platform 108 (as shown in point 4) during the pre-authorisation process and are saved in a customer database (not shown). Thus, the merchant server 106 retrieves identification data saved in the customer database and transmits the identification data to the payment terminal 112 (as shown in point 10).

The identification data are associated with the mobile wallet identifier and comprise details of the mobile wallet users registered with the mobile wallet application. The identification data may comprise, or be associated with, a customer picture, a customer name, a customer identification number, a phone number, biometric data and a password. The identification data received by the payment terminal 112 for each mobile device in range may be listed on the display screen according to the distance of the mobile device 102 to the payment terminal 112 or the second Bluetooth beacon 114 for easy reference by the store attendant to verify the user. In some embodiments, the list includes identification data for fewer than five customers.

When the customer indicates that he wishes to complete his pre-authorised payment transaction, the store attendant will identify the customer based on the identification data displayed on the display screen. For example, the store attendant may request for the identification number registered with the mobile wallet application from the customer. Upon processing the items purchased by the customer and verifying the customer, the store attendant inputs the transaction amount and selects the customer using the user interface on the display screen. It will be appreciated that the customer may describe the payment method using other descriptions, such as “hands-free payment”, “Citi hands-free” and “DBS hands-free”.

The payment terminal 112 sends the transaction amount and the information of the customer to the merchant server 106 (as shown in point 11). Using the information of the customer, the merchant server 106 determines the corresponding identifier and the transaction code. Subsequently, the merchant server 106 transmits the transaction code and the transaction amount to the acquirer server 110 and/or to a payment gateway or payment service provider for completing the payment transaction (as shown in point 12). Upon completion of the payment transaction, the merchant server 106 sends a transaction completed message to the payment terminal 112 and the mobile device 102. A purchase receipt is then printed at the payment terminal 112 and the customer leaves the store without having to present the mobile device 102 at the payment terminal 112.

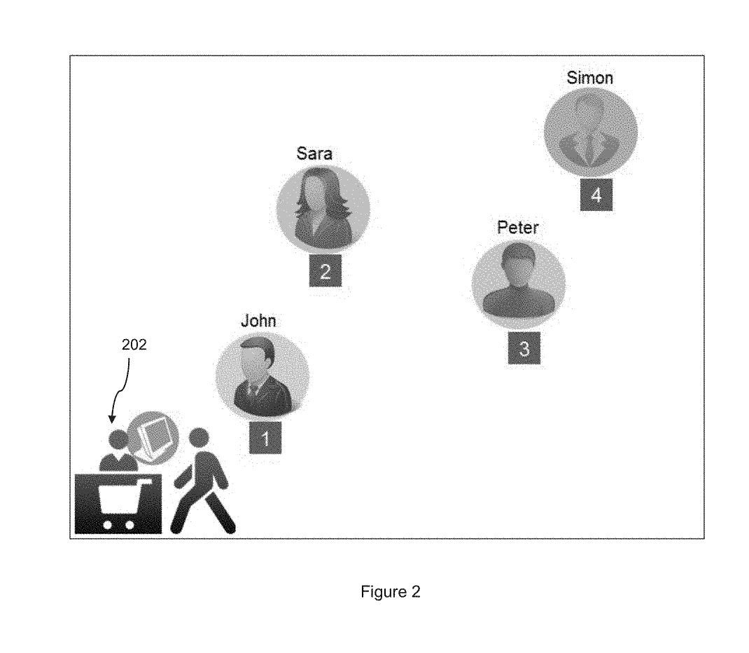

FIG. 2 shows a diagram illustrating a customer making payment at a payment terminal in accordance with an example embodiment. A list of names, i.e. John, Sara, Peter and Simon, and pictures is being displayed on a display screen of the payment terminal 202. The list is arranged according to the distance between the customers and the payment terminal 202. When the customer indicates that he wishes to make “hands-free payment”, the store attendant requests for the name of the customer and identify the customer using the picture corresponding to the name. Due to the arrangement of the list according to the distance, the details of the customer usually appear on the top of the list. The store attendant proceeds to identify and input the details of the customer and to process the items purchased by the customer.

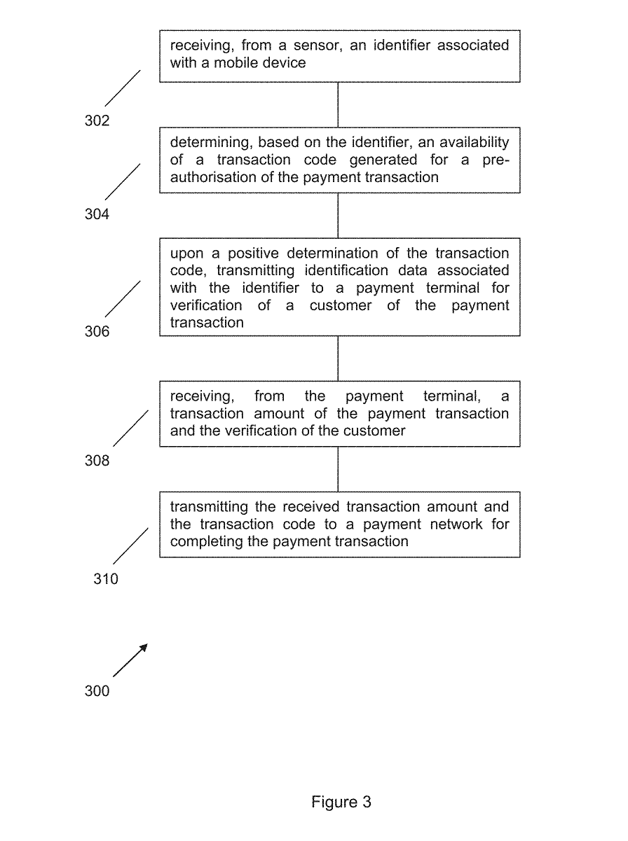

FIG. 3 shows a flow chart illustrating a method for conducting a payment transaction in accordance with an example embodiment. The method may be performed by a merchant server. At step 302, the merchant server receives an identifier associated with a mobile device from a sensor. At step 304, based on the identifier received from the sensor, the merchant server determines an availability of a transaction code generated for a pre-authorisation of the payment transaction. At step 306, upon a positive determination of the transaction code, the merchant server transmits identification data associated with the identifier to a payment terminal for verification of a customer of the payment transaction. At step 308, the merchant server receives a transaction amount of the payment transaction and the verification of the customer from the payment terminal. At step 310, the merchant server transmits the received transaction amount and the transaction code to a payment network for completing the payment transaction.

FIG. 4 depicts an exemplary computing device 400, hereinafter interchangeably referred to as a computer system 400, where one or more such computing devices 400 may be used in conducting a payment transaction (e.g. to realise the merchant server 106 and/or the payment terminal 112/202). The following description of the computing device 400 is provided by way of example only and is not intended to be limiting.

As shown in FIG. 4, the example computing device 400 includes a processor 404 for executing software routines. Although a single processor is shown for the sake of clarity, the computing device 400 may also include a multi-processor system. The processor 404 is connected to a communication infrastructure 406 for communication with other components of the computing device 400. The communication infrastructure 406 may include, for example, a communications bus, cross-bar, or network.

The software routines, or computer programs, may be stored in memory and be executable by the processor to cause the computer system 400 to: (A) receive an identifier associated with a mobile device; (B) determine, based on the identifier, an availability of a transaction code generated for a pre-authorisation of a payment transaction; (C) upon a positive determination of the transaction code, transmitting identification data associated with the identifier to a payment terminal for verification of a customer of the payment transaction; (D) receive, from the payment terminal, a transaction amount of the payment transaction and the verification of the customer; (E) transmit the received transaction amount and the transaction code to a payment network for completing the payment transaction.

The software routines, or computer programs, may also be executable by the processor to cause the computer system 400 to: (A) receive the identification data from a merchant server; (B) transmit the transaction amount of the payment transaction and the verification of the customer to the merchant server.

The software routines or computer programs may further comprise steps executable by the processor to cause the computer system 400 to perform the various other analytical steps (e.g. receiving, from the mobile device, the identifier for the payment transaction and payment instrument details used to fund the payment transaction; transmitting the payment instrument details to the payment network to initiate pre-authorisation of the payment transaction; receiving, from the payment network, the transaction code generated for the pre-authorisation of the payment transaction; and storing, in a merchant database, the transaction code received from the payment network with the identifier; processing the identifier received from the sensor against a customer database to locate the identification data associated with the identifier; transmitting the identification data associated with the identifier to the payment terminal for verification of the customer; retrieving the transaction code from the merchant database based on the identifier received from the sensor.)

The computing device 400 further includes a main memory 408, such as a random access memory (RAM), and a secondary memory 410. The secondary memory 410 may include, for example, a hard disk drive 412 and/or a removable storage drive 414, which may include a floppy disk drive, a magnetic tape drive, an optical disk drive, or the like. The removable storage drive 414 reads from and/or writes to a removable storage unit 418 in a well-known manner. The removable storage unit 418 may include a floppy disk, magnetic tape, optical disk, or the like, which is read by and written to by removable storage drive 414. As will be appreciated by persons skilled in the relevant art(s), the removable storage unit 418 includes a computer readable storage medium having stored therein computer executable program code instructions and/or data.

In an alternative implementation, the secondary memory 410 may additionally or alternatively include other similar means for allowing computer programs or other instructions to be loaded into the computing device 400. Such means can include, for example, a removable storage unit 422 and an interface 420. Examples of a removable storage unit 422 and interface 420 include a program cartridge and cartridge interface (such as that found in video game console devices), a removable memory chip (such as an EPROM or PROM) and associated socket, and other removable storage units 422 and interfaces 420 which allow software and data to be transferred from the removable storage unit 422 to the computer system 400.

The computing device 400 also includes at least one communication interface 424. The communication interface 424 allows software and data to be transferred between computing device 400 and external devices via a communication path 426. In various embodiments, the communication interface 424 permits data to be transferred between the computing device 400 and a data communication network, such as a public data or private data communication network. The communication interface 424 may be used to exchange data between different computing devices 400 which such computing devices 400 form part an interconnected computer network. Examples of a communication interface 424 can include a modem, a network interface (such as an Ethernet card), a communication port, an antenna with associated circuitry and the like. The communication interface 424 may be wired or may be wireless. Software and data transferred via the communication interface 424 are in the form of signals which can be electronic, electromagnetic, optical, or other signals capable of being received by communication interface 424. These signals are provided to the communication interface via the communication path 426.

As shown in FIG. 4, the computing device 400 further includes a display interface 402 which performs operations for rendering images to an associated display 430 and an audio interface 432 for performing operations for playing audio content via associated speaker(s) 434.

As used herein, the term “computer program product” may refer, in part, to removable storage unit 418, removable storage unit 422, a hard disk installed in hard disk drive 412, or a carrier wave carrying software over communication path 426 (wireless link or cable) to communication interface 424. Computer readable storage media refers to any non-transitory tangible storage medium that provides recorded instructions and/or data to the computing device 400 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computing device 400. Examples of transitory or non-tangible computer readable transmission media that may also participate in the provision of software, application programs, instructions and/or data to the computing device 400 include radio or infra-red transmission channels as well as a network connection to another computer or networked device, and the Internet or Intranets including e-mail transmissions and information recorded on Websites and the like.

The computer program product may thus comprise memory in which is stored instructions executable by the processor to cause the computer system 400 to: (A) receive an identifier associated with a mobile device; (B) determine, based on the identifier, an availability of a transaction code generated for a pre-authorisation of a payment transaction; (C) upon a positive determination of the transaction code, transmitting identification data associated with the identifier to a payment terminal for verification of a customer of the payment transaction; (D) receive, from the payment terminal, a transaction amount of the payment transaction and the verification of the customer; (E) transmit the received transaction amount and the transaction code to a payment network for completing the payment transaction.

The computer program product may also comprise memory in which is stored instructions executable by the processor to cause the computer system 400 to: (A) receive the identification data from a merchant server; (B) transmit the transaction amount of the payment transaction and the verification of the customer to the merchant server.

The computer program product may also comprise steps which, when executed by the processor, cause the computer system 400 to perform the various other analytical steps (e.g. receiving, from the mobile device, the identifier for the payment transaction and payment instrument details used to fund the payment transaction; transmitting the payment instrument details to the payment network to initiate pre-authorisation of the payment transaction; receiving, from the payment network, the transaction code generated for the pre-authorisation of the payment transaction; and storing, in a merchant database, the transaction code received from the payment network with the identifier; processing the identifier received from the sensor against a customer database to locate the identification data associated with the identifier; transmitting the identification data associated with the identifier to the payment terminal for verification of the customer; retrieving the transaction code from the merchant database based on the identifier received from the sensor).

The computer programs (also called computer program code) are stored in main memory 408 and/or secondary memory 410. Computer programs can also be received via the communication interface 424. Such computer programs, when executed, enable the computing device 400 to perform one or more features of embodiments discussed herein. In various embodiments, the computer programs, when executed, enable the processor 404 to perform features of the above-described embodiments. Accordingly, such computer programs represent controllers of the computer system 400.

Software may be stored in a computer program product and loaded into the computing device 400 using the removable storage drive 414, the hard disk drive 412, or the interface 420. Alternatively, the computer program product may be downloaded to the computer system 400 over the communications path 426. The software, when executed by the processor 404, causes the computing device 400 to perform functions of embodiments described herein.

It is to be understood that the embodiment of FIG. 4 is presented merely by way of example. Therefore, in some embodiments, one or more features of the computing device 400 may be omitted. Also, in some embodiments, one or more features of the computing device 400 may be combined together. Additionally, in some embodiments, one or more features of the computing device 400 may be split into one or more component parts.

In an implementation, the merchant server 106 and/or the payment terminal 112/202 may be generally described as a physical device comprising at least one processor and at least one memory including computer program code. The at least one memory and the computer program code are configured to, with the at least one processor, cause the physical device to perform the requisite operations.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A system for conducting a payment transaction, the system comprising:
a sensor for detecting a mobile device and for transmitting an identifier obtained from the mobile device;
a merchant server configured to receive the identifier from the sensor and to determine, based on the identifier, an availability of a transaction code generated for a pre-authorisation of the payment transaction, wherein upon a positive determination of the transaction code, the merchant server transmits identification data associated with the identifier for verification of a customer of the payment transaction; and
a payment terminal in communication with the merchant server for receiving the identification data from the merchant server and for transmitting a transaction amount of the payment transaction and the verification of the customer to the merchant server, wherein the merchant server transmits the received transaction amount and the transaction code to a payment network for completing the payment transaction.

2. The system as claimed in claim 1, wherein prior to receiving the identifier from the sensor, the merchant server is configured to:
receive, from the mobile device, the identifier for the payment transaction and payment instrument details used to fund the payment transaction;
transmit the payment instrument details to the payment network to initiate pre-authorisation of the payment transaction;
receive, from the payment network, the transaction code generated for the pre-authorisation of the payment transaction; and
store, in a merchant database, the transaction code received from the payment network with the identifier.

3. The system as claimed in claim 1, wherein the merchant server is further configured to:
process the identifier received from the sensor against a customer database to locate the identification data associated with the identifier; and
transmit the identification data associated with the identifier to the payment terminal for verification of the customer.

4. The system as claimed in claim 1, wherein the payment terminal is further configured to:
display the identification data received from the merchant server on a display screen; and
allow an input for verification of the customer and for obtaining the transaction amount of the payment transaction.

5. The system as claimed in claim 1, wherein the verification of the customer comprises a comparison of the identification data associated with the identifier.

6. The system as claimed in claim 2, wherein the merchant server is further configured to retrieve the transaction code from the merchant database based on the identifier received from the sensor.

7. The system as claimed in claim 1, wherein the identification data comprise one or more of: a customer picture, a customer name, a customer identification number, a phone number, biometric data and a password.

8. The system as claimed in claim 1, wherein the merchant server is further configured to transmit a notification to the mobile device upon completion of the payment transaction.

9. A computer-implemented method for conducting a payment transaction, the method comprising the steps of:
receiving, from a sensor, an identifier associated with a mobile device;
determining, based on the identifier, an availability of a transaction code generated for a pre-authorisation of the payment transaction;
upon a positive determination of the transaction code, transmitting identification data associated with the identifier to a payment terminal for verification of a customer of the payment transaction;
receiving, from the payment terminal, a transaction amount of the payment transaction and the verification of the customer; and
transmitting the received transaction amount and the transaction code to a payment network for completing the payment transaction.

10. The method as claimed in claim 9, wherein prior to receiving the identifier associated with the mobile device, the method comprising the steps of:
receiving, from the mobile device, the identifier for the payment transaction and payment instrument details used to fund the payment transaction;
transmitting the payment instrument details to the payment network to initiate pre-authorisation of the payment transaction;
receiving, from the payment network, the transaction code generated for the pre-authorisation of the payment transaction; and
storing, in a merchant database, the transaction code received from the payment network with the identifier.

11. The method as claimed in claim 9, further comprising the steps of:
processing the identifier received from the sensor against a customer database to locate the identification data associated with the identifier; and
transmitting the identification data associated with the identifier to the payment terminal for verification of the customer.

12. The method as claimed in claim 9, wherein the verification of the customer comprises a comparison of the identification data associated with the identifier.

13. The method as claimed in claim 10, further comprising the step of retrieving the transaction code from the merchant database based on the identifier received from the sensor.

14. The method as claimed in claim 9, wherein the identification data comprise one or more of: a customer picture, a customer name, a customer identification number, a phone number, biometric data and a password.

15. The method as claimed in claim 9, further comprising the step of transmitting a notification to the mobile device upon completion of the payment transaction.

16. A non-transitory computer-readable medium having stored thereon instructions executable to cause a merchant server to perform a method for conducting a payment transaction, the method comprising the steps of:
receiving, from a sensor, an identifier associated with a mobile device;
determining, based on the identifier, an availability of a transaction code generated for a pre-authorisation of the payment transaction;
upon a positive determination of the transaction code, transmitting identification data associated with the identifier to a payment terminal for verification of a customer of the payment transaction;
receiving, from the payment terminal, a transaction amount of the payment transaction and the verification of the customer; and
transmitting the received transaction amount and the transaction code to a payment network for completing the payment transaction.

17. The non-transitory computer-readable medium as claimed in claim 16, wherein prior to receiving the identifier associated with the mobile device, the method comprising the steps of:
receiving, from the mobile device, the identifier for the payment transaction and payment instrument details used to fund the payment transaction;
transmitting the payment instrument details to the payment network to initiate pre-authorisation of the payment transaction;
receiving, from the payment network, the transaction code generated for the pre-authorisation of the payment transaction; and
storing, in a merchant database, the transaction code received from the payment network with the identifier.

18. The non-transitory computer-readable medium as claimed in claim 16, further comprising the steps of:
processing the identifier received from the sensor against a customer database to locate the identification data associated with the identifier; and
transmitting the identification data associated with the identifier to the payment terminal for verification of the customer.

19. The non-transitory computer-readable medium as claimed in claim 16, wherein the verification of the customer comprises a comparison of the identification data associated with the identifier.

20. The non-transitory computer-readable medium as claimed in claim 17, further comprising the step of retrieving the transaction code from the merchant database based on the identifier received from the sensor.
